(19) United States
(12) Patent Application Publication
(10) Pub. No.: US 2020/0069490 A1
(43) Pub. Date: Mar. 5, 2020

(54) CONTROL SYSTEM FOR A LIFTING CHAIR

(71) Applicant: LIMOSS (DONGGUAN) CO., LTD., Dongguan City (CN)

(72) Inventor: Christian Gassner, Dongguan City (CN)

(73) Assignee: LIMOSS (DONGGUAN) CO., LTD., Dongguan City (CN)

(21) Appl. No.: 16/489,488

(22) PCT Filed: Oct. 19, 2017
(86) PCT No.: PCT/CN2017/106908

§ 371 Date: Aug. 28, 2019

(30) Foreign Application Priority Data
Aug. 7, 2017 (CN) 201720979273.4

(51) Int. Cl. A61G 5/14; A47C 7/56; A47C 31/00

(52) U.S. Cl. CPC A61G 5/14; A47C 31/00; A47C 7/563

(57) ABSTRACT

A control system for a lifting chair includes: a button (101), a sensor (102), an actuator (104) and a control circuit (103); the button (101) is disposed on an edge of a seat back (301) of a main body (30) of the lifting chair; the sensor (102) is configured to detect whether the seat portion (303) provided on a lifting frame (20) of the lifting chair is pressed; the actuator (104) is configured to drive the lifting frame (20); the control circuit (103) is connected to the button (101), the sensor (102), and the actuator (104) respectively; and the control circuit (103) is configured to, after the button (101) is triggered, control the actuator (104) according to a pressure condition of the seat portion (303) to drive the lifting frame (20) to adjust the posture of the main body (30).

### TECHNICAL FIELD

The present disclosure relates to the field of intelligent control technology, and for example, a control system for a lifting chair.

### BACKGROUND

When a user uses the lifting chair, the height and the inclination angle of the lifting chair (that is, the position state of the lifting chair) can be adjusted by a button embedded on an upper surface or a side surface of the armrest. For people with mobility difficulties, for example, those who have difficulties in bending to sit down, it is difficult to touch the button on the upper surface or the side surface of the armrest of the lifting chair.

Therefore, in the prior art of the lifting chair control technique, there is a problem that a person having difficulties in bending to sit down has difficulties in touching the button on the upper surface or the side surface of the armrest of the lifting chair to adjust the lifting chair.

### SUMMARY

A control system for a lifting chair can solve the problem of the lifting chair control technology in the related art that a person having difficulties in bending to sit down has difficulties in touching the button on the upper surface or the side surface of the armrest of the lifting chair to adjust the lifting chair.

A control system for a lifting chair comprises a button, a sensor, an actuator, and a control circuit. The button is disposed on an edge of a seat back of a main body of the lifting chair; the sensor is configured to detect whether a seat portion provided on a lifting frame of the lifting chair is pressed; the actuator is configured to drive the lifting frame; the control circuit is connected to the button, the sensor, and the actuator respectively; and the control circuit is configured to, after the button is triggered, control the actuator according to a pressure condition of the seat portion to drive the lifting frame to adjust a posture of the main body.

The above-mentioned chair does not require the user to bend down and thus is convenient for people with mobility difficulties.

### DESCRIPTION OF DRAWINGS

FIG. 1 is a structural diagram of a control system for lifting chair provide by an embodiment.

FIG. 2 is a structural diagram of a lifting chair in a laid-flat state provided by an embodiment.

FIG. 3 is a structural diagram of a lifting chair in a tilted-forward state provided by an embodiment.

FIG. 4 is a structural diagram of a lifting frame provided by an embodiment.

### DETAILED DESCRIPTION

In a control system for a lifting chair, a button is added on an edge of top portion of the seat back or on an edge of one of both side portions of the seat back. If the lifting chair is in a lower position relative to the user, the chair can be automatically reclined to a preset angle when a human body touches the button. The seat cushion sensor can be used to detect whether the human body touches the seat portion. If the human body touches the seat portion, the angle between the seat portion of the chair and the ground can be decreased, so that the person with mobility difficulties can sit on the chair. The control system can be applied to furniture or medical applications field.

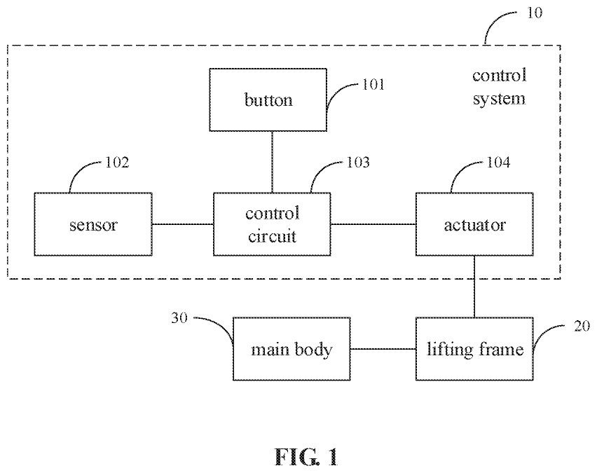

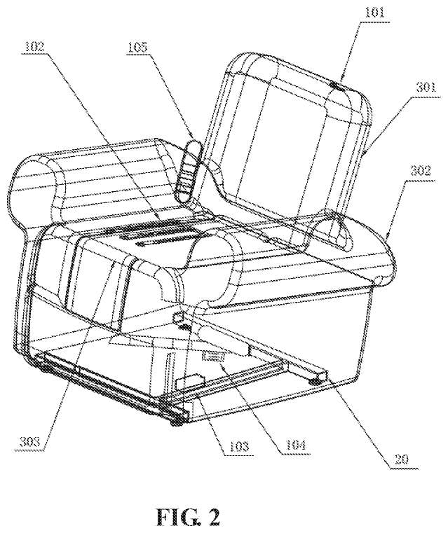

FIG. 1 is a structural diagram of a control system for a lifting chair, and FIG. 2 is a structural diagram of the lifting chair in a laid-flat state.

The control system for lifting chair includes a control system 10, a main body 30, and a lifting frame 20. The main body 30 includes an armrest 302, a seat portion 303 provided on the lifting frame 20, and a seat back 301 provided on a side of the seat portion 303. The control system 10 includes a button 101 provided at an edge of the seat back 301, a sensor 102 for detecting whether the seat portion 303 is pressed, an actuator 104 for driving the lifting frame 20 up and down, and a control circuit 103. The control circuit 103 is connected to the button 101, the sensor 102, and the actuator 104, respectively.

The control circuit 103 is configured to, after detecting that the button 101 is triggered, control the actuator 104 according to the pressure condition of the seat portion 303 to drive the lifting frame 20 to adjust the posture of the body 30.

The button 101 may be disposed on the edge of top portion of the seat back 301 or on the edge of one of both side portions of the seat back 301, and the user may stand to manipulate the button 101. After the button 101 is triggered, the lifting chair may rise, when the sensor 102 detects that the human body touches the seat portion 303 during lifting chair is rising, the lifting chair is controlled to stop rising so that the user is able to sit on the seat portion 303. The button 101 may be a touch button or a mechanical button.

In an embodiment, the control system further includes a hand controller 105. The hand controller 105 is electrically connected to the control circuit 103. The hand controller 105 is configured to send a control signal to the control circuit 103 so that the control circuit 103 controls the actuator 104.

When the human body sits on the seat portion 303, the lifting chair may be controlled to go up and down by the hand controller 105. When the lifting chair is controlled by the hand controller 105, the button 101 could be invalid.

In an embodiment, the sensor 102 includes a seat cushion sensor, and the seat cushion sensor is embedded in the seat portion 303. The cushion sensor converts gravity into an electrical signal (i.e., a feedback signal) and transmits the electrical signal to the control circuit 103. The cushion sensor is also able to measure the shaking, heartbeat or breathing of the human body.

In an embodiment, the control circuit 103 includes a controller, and the controller is disposed in the lifting frame 20. The controller may be a microprocessor. The control circuit 103 may also include peripheral circuits such as interface circuits, clock circuits, or indicator circuits with indicator lights.

In an embodiment, the actuator 104 includes a drive motor controlled by the controller, and the drive motor configured to actuate the lifting frame 20.

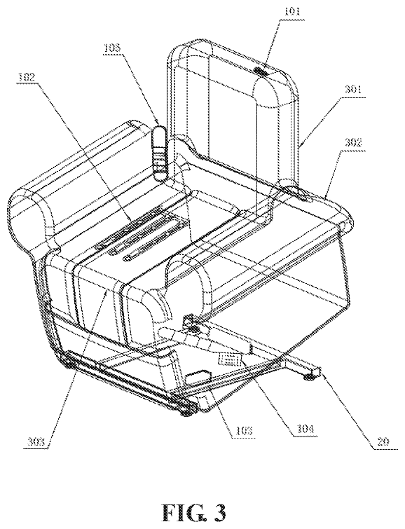

FIG. 3 shows a structure of a lifting chair in a tilted-forward.

In an embodiment, the state of the lifting chair includes a laid-flat state and a tilted-forward state.

Wherein, when the lifting chair is in the laid-flat state, the seat portion of the lifting chair is parallel to the ground; when the lifting chair is in the tilted-forward state, the main body 30 is inclined forward (as shown in FIG. 3), and a preset angle is formed between the seat portion and the horizontal. The preset angle is an angle greater than zero.

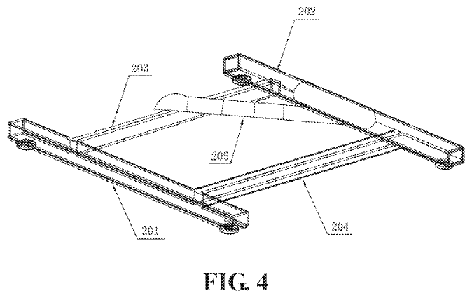

FIG. 4 shows a structure of a lifting frame.

In an embodiment, the lifting frame 20 includes a base and a telescopic support rod 205. A first end of the support rod 205 is fixed to the base, and a second end of the support rod 205 is connected to an inner wall of the seat portion 303.

In an embodiment, the base includes a first strut 201, a second strut 202, a third strut 203, and a fourth strut 204, where the first strut 201 is parallel to the second strut 202, and the third strut 203 is parallel to the fourth strut 204. The first strut 201 is vertically connected to the third strut 203 and the fourth strut 204 respectively, and the second strut 202 is vertically connected to the third strut 203 and the fourth strut 204 respectively. As shown in FIG. 4, the first end of the support rod 205 is fixed to the second strut 202.

A preset angle is formed between the plane of the base and the support rod 205. When the lifting frame 20 is controlled to go up and down, taking a connection between the main body 30 and the first strut 201 of the lifting frame 20 as an axis, the drive motor drives the support rod 205 to retract and extend, so that the main body 30 may be tilted forward to a preset angle or returned to the laid-flat state.

In an embodiment, the support rod is an electric push rod, that is, the support rod is driven by an electric signal.

Optionally, the support rod 205 is driven to retract and extend by the spiral motion of a motor output shaft.

Optionally, the support rod 205 may be driven to retract and extend by a hydraulic thrust.

In view of the above, after the button 101 is triggered (i.e., the touch button is touched or the mechanical button is pressed), the control circuit 103 may control the lifting frame 20 according to the pressure condition of the seat portion 303 (such as the gravity detected by the cushion sensor 102).

When the cushion sensor 102 fails to detect that the human body is seated on the seat portion 303 (i.e., the gravity value detected by the cushion sensor is zero), the support rod 205 of the lifting frame 20 is controlled by the control circuit 103 to be in an extended state, so that the main body 30 rises and is adjusted from the laid-flat state to the tilted-forward state. In a case where the main body 30 rises to a preset height or is ascending, when the cushion sensor 102 detects that the human body is seated on the seat portion 303 (i.e., the gravity value detected by the cushion sensor is not zero), the support rod 205 of the lifting frame 20 is controlled by the control circuit 103 to stop extending, making the main body 30 to temporarily suspend rising, so that the user can sit on the lifting chair.

When the user sits on the lifting chair and then leaves the seat portion 303, that is, when the seat cushion sensor 102 detects that no human body is seated within a preset time, the support rod 205 of the lifting frame 20 is in the retracted state, and the main body 30 is controlled to descend and adjust from the tilted-forward state to the laid-flat state. The action and posture of the main body 30 is intelligently controlled through detecting whether the human body is seated on the seat portion 303 or leaves the seat portion 303 by the seat sensor 102.

The working principle of the above control system for the lifting chair will be described below in connection with FIG. 1 to FIG. 4.

The button 101 is disposed on the edge of top portion or one of both side portions of the chair back 301 of the lifting chair. When the seat portion of the chair is lower than a preset height and no one is seated on the lifting chair, the seat portion of the lifting chair is lifted automatically to a preset height after the button 101 is operated.

During the lifting chair is in the course of rising, when the button 101 is triggered or the button of the hand controller 105 is pressed, or the seat cushion sensor detects that the human body is seated on the seat portion 303, the seat of the lifting chair stops rising.

After a person is seated on the lifting chair, the lifting chair is controlled to go up and down by the hand controller 105 and to invalidate the control function of the button. The main body 30 is controlled to lean forward to a preset angle automatically by the button 101.

After a person stands up and leaves the lifting chair, the lifting chair is controlled to return to the laid-flat state when the seat cushion sensor detects that no human body is seated within the preset time. During the lifting chair is in the course of returning to the laid-flat state, if an object or a person prevents the lifting chair from returning to the laid-flat state, a current detected by the controller reaches a preset value (no damage to the human body), and the lifting chair is controlled to remain its current state by the controller. When the button 101 on the edge of top portion or on the edge of one of both side portions of the seat back 301 is triggered by the user, the tilted-forward angle of the lifting chair can be intelligently adjusted, and the user with mobility difficulties can easily sit on the lifting chair without bending.

The control system for lifting chair provided by the above embodiments includes a main body and a lifting frame. The main body includes a seat back, an armrest, and a seat portion. A button is provided on an edge of the seat back. The lifting frame is controlled by the control system to go up and down to adjust the posture of the main body according to the pressure condition of the seat portion after the button is triggered. In the above embodiments, the control system for the lifting chair is simple in structure, can reduce the production cost, and has high practicability.

### INDUSTRIAL APPLICABILITY

The control system for the lifting chair is convenient for people with mobility difficulties.

What it is claimed is:

1. A control system for a lifting chair, comprising: a button, a sensor, an actuator and a control circuit; wherein
the button is disposed on an edge of a seat back of a main body of the lifting chair; the sensor is configured to detect whether a seat portion provided on a lifting frame of the lifting chair is pressed; the actuator is configured to drive the lifting frame; the control circuit is connected to the button, the sensor, and the actuator respectively; and the control circuit is configured to, after the button is triggered, control the actuator according to a pressure condition of the seat portion to drive the lifting frame to adjust a posture of the main body.

2. The control system according to claim 1, wherein the button is disposed on an edge of top portion of the seat back or on an edge of one of both side portions of the seat back.

3. The control system according to claim 1, wherein the posture comprises a laid-flat state and a tilted-forward state.

4. The control system according to claim 1, further comprising a hand controller, wherein the hand controller is electrically connected to the control circuit, and the hand controller is configured to send a control signal to the control circuit so that the control circuit controls the actuator.

5. The control system according to claim 1, wherein the lifting frame comprises a base and a telescopic support rod, a first end of the support rod is fixed to the base, and a second end of the support rod is connected to an inner wall of the seat portion.

6. The control system according to claim 5, wherein the base comprises a first strut, a second strut, a third strut, and a fourth strut, the first strut is parallel to the second strut, the third strut is parallel to the fourth strut, the first strut is vertically connected to the third strut and the fourth strut respectively; and the second strut is vertically connected to the third strut and the fourth strut respectively; the first end of the support rod is fixed to the second strut.

7. The control system according to claim 5, wherein a preset angle is formed between the support rod and a plane where the base is located.

8. The control system according to claim 1, wherein the sensor comprises a seat cushion sensor, and the seat cushion sensor is embedded in the seat portion.

9. The control system according to claim 1, wherein the control circuit comprises a controller disposed in the lifting frame.

10. The control system according to claim 5, wherein the actuator comprises a drive motor configured to drive the support rod to retract and extend.
